(19) United States
(12) Patent Application Publication
(10) Pub. No.: US 2006/0167209 A1
(43) Pub. Date: Jul. 27, 2006

(54) Production of polyether alcohols by usig dmc catalysis

(76) Inventors: Thomas Ostrowski, Mannheim (DE); Raimund Ruppel, Dresden (DE); Eva Baun, Schwarzheide (DE); Kathrin Harre, Dresden (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/559,073

(22) PCT Filed: Jun. 3, 2004
(86) PCT No.: PCT/EP04/06011

§ 371 Date: Mar. 30, 2006

(30) Foreign Application Priority Data
Jun. 3, 2003 (DE) 10324998.2

(51) Int. Cl. C08G 18/32; C08G 65/30; B32B 27/40

(52) U.S. Cl. 528/85; 528/425; 528/499; 528/480; 528/500

(57) ABSTRACT

The present invention relates to polyetherols are prepared by a process comprising the reaction of at least one alkylene oxide with at least one initiator compound in the presence of at least one double metal cyanide compound to give a polyetherol and the treatment of the resulting polyetherol with steam or with an inert gas and steam, and the polyetherols obtainable by such a process as well as the use thereof for the synthesis of polyurethanes.

The present invention relates to a process for the preparation of polyetherols, comprising the reaction of at least one alkylene oxide with at least one initiator compound in the presence of at least one double metal cyanide compound to give a polyetherol and the treatment of the resulting polyetherol with steam or with an inert gas and steam, the polyetherols themselves obtainable by such a process and the use thereof for the synthesis of polyurethanes.

Processes for the preparation of polyetherols are known in principle from the prior art. The use of polyetherols for the synthesis of polyurethanes is also known in principle. Polyether alcohols can be prepared, for example, by base- or acid-catalyzed polyaddition of alkylene oxides with polyfunctional initiator compounds. Suitable initiator compounds are, for example, water, alcohols, acids or amines or mixtures of two or more thereof. The disadvantage of such preparation processes is in particular that complicated purification steps are required in order to separate the catalyst residues from the reaction product. Moreover, in the case of polyetherpolyols prepared in this manner, the content of monofunctional products and compounds having an intense odor, which are not desired for the polyurethane preparation, increases with increasing chain length.

Multimetal cyanide compounds are known from the prior art as catalysts for polyadditions, in particular for ring-opening polymerizations of alkylene oxides, as described, for example, in EP-A 0 892 002, EP-A 0 862 977 and EP-A 0 755 716. DMC compounds have a high activity as a catalyst in the polymerization of epoxides.

WO 01/16209 describes a process for the preparation of polyether alcohols by catalyzed addition of ethylene oxide and propylene oxide with H-functional initiator compounds in the presence of a multimetal cyanide compound. WO 00/78837 describes the use of polyetherpolyols prepared from propylene oxide by means of multimetal cyanide catalysts for the preparation of flexible polyurethane foams. The problem here is that impurities in the polyetherpolyol, which may form as a result of secondary reactions, lead to contamination of the polyurethane prepared therefrom. Low molecular weight compounds which may lead to an odor annoyance may be mentioned in particular in this context.

The odor of polyethers for flexible foam is an important quality criterion. The close contact of the foams with the human body means that troublesome odors as well as escaping products may be harmful to the body.

It is therefore necessary to minimize the concentration of low molecular weight substances in the components required for the preparation of the foams. Since both the starting materials for the preparation of polyetherols (PO and EO) contain numerous byproducts and further components form in the reaction as a result of undesired secondary reactions, purification of the polyetherol after the synthesis is essential. In many cases, such impurities can lead to compounds having an intense odor in the polyurethanes prepared from the polyetherpolyols. Consequently, the polyurethanes or polyurethane foams have only limited applications. The reduction of the impurities in polyether alcohols is therefore of wide interest. Particularly for use in the automotive and furniture industries, there is an increasing demand for polyurethanes which are as free as possible of odorous substances and emissions.

For example, EP-B 0 776 922 describes a process for the synthesis of polyetherpolyols using double metal cyanide compounds, alkylene oxide remaining after the alkylene oxide addition with the initiator compound being removed under reduced pressure, if required with treatment with nitrogen.

Starting from this prior art, it is an object of the present invention to provide further processes for the preparation of polyetherols which firstly are economical and moreover give products which have a low content of low molecular weight byproducts.

We have found that this object is achieved, according to the invention, by a process for the preparation of at least one polyetherol, at least comprising the following steps
(1) reaction of at least one alkylene oxide with at least one initiator compound in the presence of at least one double metal cyanide compound to give a polyetherol; and
(2) treatment of the polyetherol from step (1) with steam or with an inert gas and steam.

According to the process according to the invention, a polyetherol is first prepared and is then treated with steam or with inert gas and with steam. The novel process leads to polyetherols which have a surprising low content of impurities. It is particularly surprising that the steam treatment of polyetherols which were synthesized by means of DMC catalysis leads to a more effective separation of impurities than the corresponding treatment of polyetherols which were obtained by means of KOH synthesis. This is surprising, for example, because the treatment of polyetherols which still have DMC catalyst residues appears problematic in principle. For example, chain degradation might occur.

The treatment according to the invention with steam or with a mixture of steam and inert gas leads to a particularly economical process since the steam can be condensed after the synthesis. As a result of the condensation of the steam, the hydrodynamic gas quantity which has to be removed by the exhaust air system is reduced. This reduces the size of both the vacuum pipes and the apparatuses for generating reduced pressure which lowers the capital costs. When noncondensable gases are used, the total hydrodynamic load over the pipes and vacuum units has to be processed. In the present invention, it is therefore particularly preferable to treat the polyetherol obtained according to step (1) with steam alone in step (2).

In a preferred embodiment, the present invention therefore relates to a process for the preparation of at least one polyetherol, the treatment according to step (2) being carried out using steam alone.

According to the invention, it is further preferred if the treatment according to step (2), i.e. a stripping process, is carried out as long as the product of the reaction according to step (1) is fresh. According to the invention, the removal of troublesome odorous substances is effected in a shorter time if the product is fresh. This is surprising in that the catalyst is still active and, for example, reactions of the stripping medium (water) with the polyetherol might take place. The product stored for several days at 20° C. is substantially more difficult to deodorize. In the context of the present invention, a fresh product is understood as meaning that the product was stored for no longer than 12 hours after the end of the reaction according to step (1).

In the process according to the invention, step (2) is therefore preferably carried out within twelve hours after step (1), in particular within six hours after step (1), preferably three hours after step (1), particularly preferably 30 minutes after step (1).

According to the invention, step (2) can be carried out in the reaction vessel itself or in a separate container. According to the invention, it is particularly preferable if the polyetherol is pumped out of the reactor after step (1) and is transferred directly into a stripping container in which the treatment according to step (2) then takes place. This embodiment moreover has the advantage that expensive reactor time can be saved since the step (2) is carried out in a separate reaction vessel.

In a further embodiment, the present invention therefore relates to a process for the preparation of at least one polyetherol, step (2) being carried out within 12 hours after step (1).

All compounds which have an active hydrogen are suitable as the initiator compound. According to the invention, preferred initiator compounds are OH-functional compounds.

According to the invention, for example, the following compounds are suitable as the initiator compound: water, organic dicarboxylic acids, such as succinic acid, adipic acid, phthalic acid and terephthalic acid, and monohydric or polyhydric alcohols, such as monoethylene glycol, 1,2- and 1,3-propanediol, diethylene glycol, dipropylene glycol, 1,4-butanediol, 1,6-hexanediol, glycerol, trimethylolpropane, pentaerythritol, sorbitol and sucrose. Adducts of ethylene oxide and/or propylene oxide with water, monoethylene glycol, diethylene glycol, 1,2-propanediol, dipropylene glycol, glycerol, trimethylolpropane, ethylenediamine, triethanolamine, pentaerythritol, sorbitol and/or sucrose, individually or as mixtures, are preferably used as polyether polyalcohols.

According to the invention, the initiator compounds can also be used in the form of alkoxylates. Alkoxylates having a molecular weight M_{w} of from 62 to 15 000 g/mol are particularly preferred.

However, other suitable initiator compounds are macromolecules having functional groups which have active hydrogen atoms, for example hydroxyl groups, in particular those which are mentioned in WO 01/16209.

Particularly preferred initiator compounds are monofunctional or polyfunctional alcohols of 2 to 24 carbon atoms; according to the invention, initiator compounds of 8 to 15, in particular 10 to 15, carbon atoms are particularly preferred.

In principle, all suitable alkylene oxides may be used for the process according to the invention. For example, C₂-C₂₀-alkylene oxides, such as ethylene oxide, propylene oxide, 1,2-butylene oxide, 2,3-butylene oxide, isobutylene oxide, pentene oxide, hexene oxide, cyclohexene oxide, styrene oxide, dodecene epoxide, octadecene epoxide and mixtures of these epoxides are suitable. Ethylene oxide, propylene oxide, 1,2-butylene oxide, 2,3-butylene oxide and pentene oxide are particularly suitable, propylene oxide, 1,2-butylene oxide, 2,3-butylene oxide and isobutylene oxide being particularly preferred.

In principle, all suitable compounds known to a person skilled in the art may be used as a DMC compound.

DMC compounds suitable as a catalyst are described, for example, in WO 99/16775 and in DE 10117273.7. The following are particularly suitable as a catalyst for the alkoxylation of a double metal cyanide compound of the formula I:
M¹ₐ[M²(CN)_{b}(A)_{c}]_{d}·fM¹_{g}Xₙ·h(H₂O)·eL·kP (I),
where
M¹ is at least one metal ion selected from the group consisting of Zn²⁺, Fe²⁺, Fe³⁺, Co³⁺, Ni²⁺, Mn²⁺, Co²⁺, Sn²⁺, Pb²⁺, Mo⁴⁺, Mo⁶⁺, Al³⁺, V⁴⁺, V⁵⁺, Sr²⁺, W⁴⁺, W⁶⁺, Cr²⁺, Cr³⁺, Cd²⁺, Hg²⁺, Pd²⁺, Pt²⁺, V²⁺, Mg²⁺, Ca²⁺, Ba²⁺, Cu²⁺, La³⁺, Ce³⁺ Ce⁴⁺, Eu³⁺, Ti³⁺, Ti⁴⁺, Ag⁺, Rh²⁺, Rh³⁺, Ru²⁺ and Ru³⁺,
M² is at least one metal ion selected from the group consisting of Fe²⁺, Fe³⁺, Co²⁺, Co³⁺, Mn²⁺, Mn³⁺, V⁴⁺, V⁵⁺, Cr²⁺, Cr³⁺, Rh³⁺, Ru²⁺ and Ir³⁺,
A and X, independently of one another, are each an anion selected from the group consisting of halide, hydroxide, sulfate, carbonate, cyanide, thiocyanate, isocyanate, cyanate, carboxylate, oxalate, nitrate, nitrosyl, hydrogen sulfate, phosphate, dihydrogen phosphate, hydrogen phosphate and bicarbonate,
L is a water-miscible ligand selected from the group consisting of alcohols, aldehydes, ketones, ethers, polyethers, esters, polyesters, polycarbonate, ureas, amides, primary, secondary and tertiary amines, ligands having pyridine nitrogen, nitriles, sulfides, phosphides, phosphites, phosphines, phosphonates and phosphates,
k is a fraction or integer greater than or equal to zero and
P is an organic additive,
a, b, c, d, g and n are selected so that the electroneutrality of the compound (I) is ensured, it being possible for c to be 0,
e is the number of ligand molecules and is a fraction or integer greater than 0 or 0,
f, h and m, independently of one another, are a fraction or integer greater than 0 or 0.

Examples of organic additives P are: polyether, polyester, polycarbonates, polyalkylene glycol sorbitan ester, polyalkylene glycol glycidyl ether, polyacrylamide, poly(acrylamide-co-acrylic acid), polyacrylic acid, poly(acrylamide-co-maleic acid), polyacrylonitrile, polyalkylene acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkylenimines, maleic acid and maleic anhydride copolymers, hydroxyethylcellulose, polyacetates, ionic surface-active and interface-active compounds, gallic acid or salts, esters or amides thereof, carboxylic esters of polyhydric alcohols and glycosides.

These catalysts may be crystalline or amorphous. Where k is zero, crystalline double metal cyanide compounds are preferred. Where k is greater than zero, crystalline, semicrystalline and substantially amorphous catalysts are preferred.

There are various preferred embodiments of the modified catalysts. A preferred embodiment comprises catalysts of the formula (I) in which k is greater than zero. The preferred catalyst then contains at least one double metal cyanide compound, at least one organic ligand and at least one organic additive P.

In another preferred embodiment, k is zero, e is optionally also zero and X is exclusively a carboxylate, preferably formate, acetate or propionate. Such catalysts are described in WO 99/16775. In this embodiment, crystalline double metal cyanide catalysts are preferred. Furthermore, double metal cyanide catalysts as described in WO 00/74845, which are crystalline or lamellar, are preferred.

The modified catalysts are prepared by combining a metal salt solution with a cyanometallate solution, which solution may optionally contain both an organic ligand L and an organic additive P. The organic ligand and optionally the organic additive are then added. In a preferred embodiment of the catalyst preparation, an inactive double metal cyanide phase is first prepared and this is then converted into an active double metal cyanide phase by recrystallization, as described in PCT/EP01/01893.

In another preferred embodiment of the catalysts, f, e and k are not zero. These are double metal cyanide catalysts which contain a water-miscible organic ligand (in general in amounts of from 0.5 to 30% by weight) and an organic additive (in general in amounts of from 5 to 80% by weight), as described in WO 98/06312. The catalysts can be prepared either with vigorous stirring (24 000 rpm using a Turrax) or with stirring, as described in U.S. Pat. No. 5,158,922.

Double metal cyanide compounds which contain zinc, cobalt or iron or two thereof are particularly suitable as a catalyst for the alkoxylation. For example, Prussian blue is particularly suitable.

Crystalline DMC compounds are preferably used. In a preferred embodiment, a crystalline DMC compound of the Zn—Co type which contains zinc acetate as a further metal salt component is used. Such compounds crystallize in a monoclinic structure and have a lamellar habit. Such compounds are described, for example, in WO 00/74845 or PCT/EP01/01893.

DMC compounds suitable as a catalyst can in principle be prepared by all methods known to a person skilled in the art. For example, the DMC compounds can be prepared by direct precipitation, the incipient wetness method, by preparation of a precursor phase and subsequent recrystallization.

The DMC compounds can be used in the form of a powder, paste or suspension or can be shaped to give a molding, introduced into moldings, foams or the like or applied to moldings, foams or the like.

The catalyst concentration used for the alkoxylation, based on the final quantity range, is typically less than 2000 ppm, preferably less than 1 000 ppm, in particular less than 500 ppm, particularly preferably less than 100 ppm, for example less than 50 ppm.

The addition reaction is carried out at from about 90 to 240° C., preferably from 120 to 180° C., in a closed vessel. The alkylene oxide is fed to the reaction mixture under the vapor pressure of the alkylene oxide mixture prevailing at the chosen reaction temperature. If desired, the alkylene oxide, in particular ethylene oxide, can be diluted with up to about 30 to 60% of an inert gas. This results in additional safety with respect to explosive decomposition of the alkylene oxide, in particular of the ethylene oxide.

If an alkylene oxide mixture is used, polyether chains in which the various alkylene oxide building blocks are virtually randomly distributed are formed. Variations in the distribution of the building blocks along the polyether chain are the result of different reaction rates of the components and can also be achieved arbitrarily by continuous feeding of an alkylene oxide mixture of a program-controlled composition. If the various alkylene oxides are reacted in succession, polyether chains having a block-like distribution of the alkylene oxide building blocks are obtained.

The length of the polyether chains varies randomly within the reaction product about a mean value of the stoichiometric values substantially resulting from the amount added.

The addition of acid before the treatment according to step (2), i.e. before the stripping, or before the synthesis according to step (1), may facilitate the stripping process. It is possible, for example, for aldehydes bonded as acetals to the alcohol terminal groups to be cleaved by the addition of acid, which may lead to shorter stripping times. According to the invention, it is therefore preferable if a pH of less than 10 is present during the treatment according to step (2). According to the invention, however, the pH should not fall below 5.0, preferably not below 5.5, since the addition of too large an amount of acid adversely affects the subsequent polyurethane synthesis. It was found that the possible cleavage of the polyether chain by the acid with formation of low molecular weight products is not disadvantageous for the stripping result and the stripping time.

In a further embodiment, the present invention therefore relates to a process for the preparation of at least one polyetherol, a pH of less than 10 being present during the treatment according to step (2).

According to the invention, the acid number of the polyetherol after the addition of acid is preferably from 0.01 to 0.5, especially from 0.01 to 0.1, particularly preferably from 0.01 to 0.05, mg KOH/g.

In a further preferred embodiment, the present invention therefore relates to a process for the preparation of at least one polyetherol, the polyetherol having an acid number of from 0.01 to 0.5 mg KOH/g before the treatment according to step (2).

In principle, all suitable acids known to a person skilled in the art are suitable in the context of the present invention for establishing the pH or the acid number. According to the invention, mineral acids, for example sulfuric acid, phosphoric acid, chloric acid, perchloric acid, iodic acid, periodic acid, bromic acid or perbromic acid, are particularly suitable, preferably sulfuric acid or phosphoric acid.

The process according to the invention can be carried out batchwise or continuously. The process according to the invention is preferably carried out batchwise.

In a further embodiment, the present invention therefore relates to a process for the preparation of at least one polyetherol, the process being carried out batchwise.

According to the invention, a pure bubble column or a stirred bubble column can be used for the treatment according to step (2), provided that the process is carried out in batch operation. It is preferable according to the invention to use a pure bubble column. In batch operation, it has been found that a pure bubble column is more effective than a stirred bubble column. This is surprising because it is to be expected that the residence time of the bubbles is longer in the stirred bubble column and that large bubbles are broken up and hence the stripping process should be more effective.

According to the invention, it is additionally possible to add a stabilizer to the reaction mixture or to one of the components before or after the reaction according to step (1) or during the treatment according to step (2). Said stabilizer can prevent the formation of undesired byproducts due to oxidation processes. In a further preferred embodiment, the present invention therefore relates to a process for the preparation of at least one polyetherol, a stabilizer being added before or during the treatment according to step (2).

In the present invention, all stabilizers known to a person skilled in the art can in principle be used.

These components include free radical acceptors, peroxide decomposers, synergistic agents and metal deactivators.

Antioxidants used are, for example, sterically hindered phenols and aromatic amines.

Examples of suitable phenols are alkylated monophenols, such as 2,6-di-tert-butyl-4-methylphenol (BHT), 2-butyl-4,6-dimethylphenol, 2,6-di-tert-butyl-4-methoxyphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, linear nonylphenols or nonylphenols branched in the side chain, such as 2,6-dinonyl-4-methylphenol, 2,4-dimethyl-6-(1′-methyl-undec-1′-yl)phenol, 2,4-dimethyl-6-(1′-methyl-heptadec-1′-yl)phenol, 2,4-dimethyl-6-(1′-methyl-tridec-1′-yl)phenol and mixtures thereof;

alkylthiomethylphenols, such as 2,4-dioctylthiomethyl-6-tert-butylphenol, 2,4-di-octylthiomethyl-6-methylphenol, 2,4-dioctylthiomethyl-6-ethylphenol, octyl(3,5-di-tert-butyl-4-hydroxyphenyl)propionate (Irganox 11135) or 2,6-didodecylthiomethyl-4-nonylphenol;

tocopherols, such as α-tocopherol, β-tocopherol, γ-tocopherol, δ-tocopherol and mixtures thereof;

hydroxylated thiodiphenyl ethers, such as 2,2′-thiobis(6-tert-butyl-4-methylphenol), 2,2′-thiobis(4-octylphenol), 4,4′-thio-bis(6-tert-butyl-3-methylphenol), 4,4′-thiobis(6-tert-butyl-2-methylphenol), 4,4′-thiobis(3,6-di-sec-amylphenol), thiodiphenylamine (phenothiazine), or 4,4′-bis(2,6-dimethyl-4-hydroxyphenyl)disulfide;

alkylidenebisphenols, such as 2,2′-methylenebis(6-tert-butyl-4-methylphenol), 2,2′-methylenebis(6-tert-butyl-4-ethylphenol), 2,2′-methylenebis(6-tert-butyl-4-butylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 1,1-bis(5-tert-butyl-4-hydroxy-2-methylphenyl)butane, 2,6-bis(3-tert-butyl-5-methyl-2-hydroxy-benzyl)₄-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate, bis(3-tert-butyl-4-hydroxy-5-methylphenyl)dicyclopentadiene, 1,1-bis(3,5-dimethyl-2-hydroxyphenyl)butane, 2,2-bis(3,5-di-tert-butyl-4-hydroxyphenyl)propane, 2,2-bis(3,5-di-tert-butyl-4-hydroxy-2-methylphenyl)-4-n-dodecylmercaptobutane or 1,1,5,5-tetra(5-tert-butyl-4-hydroxy-2-methylphenyl)pentane;

and other phenols, such as methyl(3,5-di-tert-butyl-4-hydroxyphenyl)propionate (PS40), octadecyl(3,5-di-tert-butyl-4-hydroxyphenyl)propionate (Irganox 11076), N,N′-hexamethylenebis(3,5-di-tert-butyl-4-hydroxyhydrocinnamide), tetrakis[methylene(3,5-di-tert-butyl-4-hydroxyhydrocinnamoyl)]methane, 2,2′-oxamidobis[ethyl-3(3,5-di-tert-butyl-4-hydroxyphenyl)]propionate or tris-(3,5-di-tert-butyl-4-hydroxybenzyl)isocyanurate.

Examples of suitable amines are 2,2,6,6-tetramethylpiperidine, N-methyl-2,2,6,6-tetramethylpiperidine, 4-hydroxy-2,2,6,6-tetramethylpiperidine, bis(2,2,6,6-tetramethyl-4-piperidyl) sebacate, bis(N-methyl-2,2,6,6-tetramethyl-4-piperidyl) sebacate, butylated and octylated diphenylamines (Irganox 15057 and PS30), N-allyldiphenylamine, 4-isopropoxydiphenylamine, N-phenyl-1-naphthylamine, N-phenyl-2-naphthylamine, 4-dimethylbenzyldiphenylamine, etc.

Synergistic agents include, for example, compounds from the group consisting of the phosphites, phosphonites and hydroxylamines, for example triphenyl phosphite, diphenyl alkyl phosphites, phenyl dialkyl phosphites, tris(nonylphenyl) phosphite, trilauryl phosphite, trioctadecyl phosphite, tris(2,4-di-tert-butylphenyl) phosphite, diisodecyl pentaerythrityl diphosphite, bis(2,4-di-tert-butylphenyl)pentaerythrityl diphosphite, bis(2,6-di-tert-butyl-4-methylphenyl)pentaerythrityl diphosphite, bisisodecyloxypentaerythrityl diphosphite, bis(2,4-di-tert-butyl-6-methylphenyl)pentaerythrityl diphosphite, bis(2,4,6-tri-tert-butylphenyl) pentaerythrityl diphosphite, tristearyl sorbitol trisphosphite, tetrakis(2,4-di-tert-phenyl) 4,4′-biphenylene diphosphite, 6-isooctyloxy-2,4,8,10-tetra-tert-butyl-12H-dibenzo[d,g]-1,3,2-dioxaphosphocin, 6-fluoro-2,4,8,10-tetra-tert-butyl-12-methyl-dibenzo[d,g]-1,3,2-dioxaphosphocin, bis(2,4-di-tert-butyl-6-methylphenyl)methylphosphite, bis(2,4-di-tert-butyl-6-methylphenyl)ethylphosphite, N,N-dibenzylhydroxylamine, N,N-diethylhydroxylamine, N,N-dioctylhydroxylamine, N,N-dilauylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine or N,N-dialkylhydroxylamine from hydrogenated tallow fatty amines;

metal deactivators are, for example, N′-diphenyloxalamide, N-salicylal-N′-salicyloylhydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalic acid dihydrazide, oxanilide, isophthalic acid dihydrazide, sebacic acid bisphenylhydrazide, N,N′-diacetyladipic acid dihydrazide, N,N′-bissalicyloyloxalic acid dihydrazide and N,N′-bissalicyloylthiopropionic acid dihydrazide.

Stabilizers preferred according to the invention are 2,6-di-tert-butyl-4-methylphenol (BHT), octyl(3,5-di-tert-butyl-4-hydroxyphenyl)propionate (Irganox 11135), thiodiphenylamine (phenothiazine), methyl(3,5-di-tert-butyl-4-hydroxyphenyl)propionate (PS40), octadecyl (3,5-di-tert-butyl-4-hydroxyphenyl)propionate (Irganox 11076) and butylated and octylated diphenylamines (Irganox 15057 and PS30).

The present invention moreover relates to the polyetherols obtainable by a novel process. The present invention therefore also relates to a polyetherol obtainable by a process at least comprising the following steps
(1) reaction of at least one alkylene oxide with at least one initiator compound in the presence of at least one double metal cyanide compound to give a polyetherol; and
(2) treatment of the polyetherol from step (1) with steam or with an inert gas and steam.

The polyetherols obtainable by a process according to the invention have in particular a low content of impurities. This is substantially evident from the low odor of the polyol and low fogging and VOC values, which are important for the automotive and furniture industries.

Owing to the low contents of impurities, the polyetherols prepared according to the invention are particularly suitable for the preparation of polyurethanes. The present invention therefore also relates to the use of a polyetherol obtainable by a process according to the invention or of a polyetherol according to the invention for the synthesis of polyurethanes.

The polyetherols prepared according to the invention are particularly suitable for the preparation of polyurethane foams, polyurethane cast skins and elastomers. The polyetherols prepared according to the invention are preferably used for the synthesis of flexible polyurethane foam. These may be, for example, flexible slabstock foams or flexible molded foams. In a further embodiment, the present invention therefore relates to the use of a polyetherol obtainable by a process according to the invention or of a polyetherol according to the invention for the synthesis of polyurethanes, the polyurethane being a flexible polyurethane foam.

Particularly preferred polyurethane foams are foams which are used in the automotive and furniture industries. Such polyurethanes are suitable, for example, for the production of moldings, in particular moldings of flexible polyurethane slabstock foam. The low content of impurities is advantageous here since this prevents the occurrence of troublesome odors which may emerge from the shaped flexible foam article. Moreover, the VOC and fogging values are low.

Moldings according to the invention are, for example, mattresses, cushions, shaped articles for the automotive industry or upholstered furniture.

The examples which follow illustrate the present invention.

### EXAMPLES

General Preparation Method:

Catalyst Preparation:

The catalyst preparation was carried out according to example 1 of EP-A 0 862 947.

200 ml of strongly acidic ion exchanger K2431 from Bayer AG were regenerated with 80 g of 37% strength hydrochloric acid and washed with water until the discharge was neutral. A solution of 17.8 g of potassium hexacyanocobaltate in 100 ml of water was then added to the exchange column. The column was then eluted until the discharge was neutral again. The 368 g of eluate thus obtained were heated to 40° C., and a solution of 20.0 g of zinc acetate in 100 ml of water was added with stirring. The resulting suspension was stirred for a further 10 minutes at 40° C. Thereafter, 84 g of ethylene glycol dimethyl ether were added and the solution was stirred for a further 30 minutes at 40° C. Thereafter, the solid was filtered off with suction and washed on the filter with 300 ml of ethylene glycol dimethyl ether. The solid thus treated was dried at room temperature. The potassium content was determined by means of atomic adsorption spectroscopy. No potassium was detectable (limit of detection 10 ppm). The catalyst was dispersed in a propoxylate (prepared by means of KOH catalysis, glycerol-initiated, OH number: 298 mg KOH/g) worked up with phosphoric acid, so that a DMC concentration of 4.53% resulted.

Polyol Synthesis:

44 g of a 4.53% strength DMC catalyst suspension (corresponding to 100 ppm of DMC catalyst, based on the product to be prepared) were added, in a 20 l stirred kettle reactor, to 3 200 g of a glycerol-initiated propoxylate worked up with phosphoric acid and having an OH number of 298 mg KOH/g and dewatering was effected at 120° C. and a reduced pressure of about 40 mbar until the water content was below 0.02%. Thereafter, about 400 g of propylene oxide were metered in and a waiting period was allowed for the initiation of the reaction, which was detectable from a brief tempeature increase and a rapid decrease in the reactor pressure. Thereafter, 16 450 g of a mixture of 14 910 g of propylene oxide and 1 940 g of ethylene oxide were metered in at the same temperature in a period of about 2.5 hours. After a constant reactor pressure had been reached after the end of the metering, unconverted monomers and other volatile components were distilled off under reduced pressure and the product was discharged.

The colorless polyether alcohol obtained had the following characteristics:

| OH number | 48.8 mg KOH/g (determined according to ASTM D |
|---|---|
| | 2849) |
| Acid number | 0.013 mg KOH/g |
| Water content | 0.011% |
| Viscosity (25° C.) | 566 mPa · s |
| Mw | 3 055 g/mol |
| D | 1.375 |

### Example 1

Fresh product, directly from the reactor, was stripped. A part of this product was cooled under nitrogen and stored for 5 days at 20° C. (nitrogen fogging). This product was then also stripped. The differences between the areas of the starting sample constitute the usual error of measurement of the method.

A bubble column (ID=10 cm) which had a double jacket for heating and a ring distributor (d=4 cm) with numerous holes at the bottom for gas introduction was used for the stripping process. The temperature of the bubble column was kept constant using commercial thermostats which are operated using thermal oil. The water required for the stripping was vaporized by means of an electrical water evaporator (GESTRA GmbH, Bremen, DINO electric steam generator, type NDD 18) and fed into the bubble column via the ring distributor. The pressure in the bubble column was kept constant at 300 mbar by means of a vacuum pump. The same gas distributor was used for nitrogen. Nitrogen was taken from a commercial compressed gas cylinder (6.0 quality).

For the stripping, the polyol prepared was pumped under inert conditions at room temperature by means of a pump into a bubble column provided with an inert atmosphere by means of nitrogen. The polyol was then heated to the stripping temperature. At the same time, the pressure in the bubble column was adjusted. Steam and/or nitrogen were fed in via a ring distributor, the amount being monitored by means of a steam meter or rotameter. After the stripping process with steam, the latter was shut off and the product was dried by means of nitrogen (13 l(S.T.P.)/h). The nitrogen was fed in via the same ring distributor.

The headspace areas were determined by means of gas chromatography. The polyol was first stabilized with 4 000 ppm of BHT. About 3 g of sample were introduced into 10 ml sample bottles and the latter were closed with septa resistant to high temperatures. Thereafter, the sample was introduced into the autosampler and heated at 140° C. for exactly 2 hours. During this procedure, the gas phase (headspace) formed above the liquid. After the heating time, the gas phase was analyzed by means of gas chromatography. The headspace areas were determined by means of flame ionization detectors.

Analysis Conditions:

Column: DB-Wax (0.25 mm ID, 0.25 μm film thickness, 30 m)

Carrier gas: Helium

Combustion gas: Hydrogen and synthetic air (optimized)

Admission pressure: at GC 7.5 psi

Flow rate: 0.5 ml/min

Temperature (detector): 250° C.

Temperature (injector): 150° C.

Temperature (oven): 10 min 50° C./10′/min, 240° C. 20 min

Split ratio: 1:20

Equilibration time: 001

Bath temperature: 140° C. (120° C.)

Valve/loop temp.: 150° C. (130° C.)

Integration method: PO 2.MTH

TABLE 1.1
Conditions: 6 kg of product, 80 g of water per minute, reactor
diameter 10 cm. Headspace areas determined at 140° C., heat
for 2 h, stabilized product (4 000 ppm of BHT). T = 120° C.,
η_{120° C., fresh product} = 11 mPa · s,
η_{120° C., old product} = 12.5 mPa · s

| | Fresh product | Aged product |
|---|---|---|
| Stripping time, h | Areas | Areas |
| 0 | 254 871 | 248 957 |
| 2 | 51 240 | 122 415 |
| 4 | 24 888 | 74 521 |
| 6 | 2 419 | 10 248 |

### Example 2

Example 2 was prepared analogously to example 1. The fresh product was used in the stripping.

TABLE 2.1
Conditions: 6 kg of product, 80 g of water per minute in steam
stripping, 13 1(S.T.P.)/min during nitrogen stripping, reactor
diameter 10 cm. Headspace areas determined at 140° C., heat for 2 h,
stabilized product (4 000 ppm of BHT). T = 120° C., η_{120° C.,}
_{fresh product} = 11 mPa · s

| | Fresh DMC product, | Fresh DMC product, |
|---|---|---|
| | steam stripping, | nitrogen stripping, |
| Stripping time, h | areas | areas |
| 0 | 254 871 | 254 880 |
| 2 | 51 240 | 112 548 |
| 4 | 24 888 | 58 745 |
| 6 | 2 419 | 14 525 |

### Example 3

Example 3 was carried out analogously to example 1. The pH of the original product was then brought to a value of 6.0 or 8.0 by adding phosphoric acid.

TABLE 3.1
Conditions: 6 kg of product, 80 g of steam per minute,
reactor diameter 10 cm, headspace areas determined at 140° C.,
heat for 2 h, stabilized product (4 000 ppm of BHT). T = 120° C.,
η_{120° C., fresh product, pH = 6.0} = 11 mPa · s,
η_{120° C., fresh product, pH = 8.0} = 11 mPa · s

| | Fresh DMC product, | Fresh DMC product, |
|---|---|---|
| | steam stripping, | steam stripping, |
| | areas | areas |
| Stripping time, h | pH = 6.0 | pH = 8.0 |
| 0 | 254 871 | 254 825 |
| 2 | 51 240 | 75 254 |
| 4 | 24 888 | 42 587 |
| 6 | 2 419 | 9 874 |

### Example 4

Example 4 was carried out analogously to example 1. A stirred kettle having a volume of 20 l was used. The stirred kettle was equipped with an inclined-blade stirrer. The steam was fed in with the aid of a gas distributor ring at the bottom of the reactor.

TABLE 4.1
Conditions: 10 kg of product, steam stripping with 250 g of
steam per minute, reactor diameter 10 cm. Headspace areas
determined at 140° C., heat for 2 h, stabilized product
(4 000 ppm of BHT). T = 120° C., η_{120° C.,}
_{fresh product} = 11 mPa · s

| | Fresh DMC product, | Fresh DMC product, |
|---|---|---|
| | with stirrer, | without stirrer, |
| Stripping time, h | areas | areas |
| 0 | 258 154 | 257 998 |
| 2 | 121 416 | 56 522 |
| 4 | 58 745 | 23 356 |
| 6 | 15 423 | 5 487 |

### Example 5

Example 5 was carried out analogously to example 1. In order to investigate the influence of the stabilizer addition, the stabilizer was added on the one hand before the synthesis and on the other hand before the stripping. For comparison, a third experiment without addition of stabilizer was carried out. For cases two and three, the same product was used. Only steam stripping in the bubble column without a stirrer was tested. 1 000 ppm of Irganox I1 135 were used as the stabilizer.

TABLE 5.1
Conditions: 6 kg of product, 80 g of steam per minute, reactor
diameter 10 cm. Headspace areas determined at 140° C., heat
for 2 h, stabilized product (4 000 ppm of BHT). T = 120° C.,
η_{120° C., fresh product, without stabilizer} = 11 mPa · s,
η_{120° C., fresh product with stabilizer} = 11 mPa · s,
η_{120° C., fresh product prepared with stabilizer} = 11 mPa · s

| | Fresh DMC | Fresh DMC product, | Fresh DMC product, |
|---|---|---|---|
| | product, product | stabilizer added | stabilizer added |
| Stripping | without stabilizer | before the stripping | before the synthesis |
| time, h | Areas | Areas | Areas |
| 0 | 254 871 | 255 223 | 198 547 |
| 2 | 51 240 | 235 48 | 19 874 |
| 4 | 24 888 | 9 854 | 5 875 |
| 6 | 2 419 | 223 | 275 |
| Stabilizer | 0 | 850 | 800 |
| content | | | |
| after the | | | |
| stripping | | | |

1-9. (canceled)

10. A process for the preparation of at least one polyetherol, at least comprising the following steps
(1) reaction of at least one alkylene oxide with at least one initiator compound in the presence of at least one double metal cyanide compound to give a polyetherol; and
(2) treatment of the polyetherol from step (1) with steam or with an inert gas and steam,
wherein a pH of less than 10 is present during the treatment according to step (2).

11. The process as claimed in claim 10, wherein the treatment according to step (2) is carried out using steam alone.

12. The process as claimed in claim 10, wherein step (2) is carried out within 12 hours after step (1).

13. The process as claimed in claim 10, wherein the polyetherol has an acid number of from 0.01 to 0.5 mg KOH/g before the treatment according to step (2).

14. The process as claimed in claim 11, wherein the polyetherol has an acid number of from 0.01 to 0.5 mg KOH/g before the treatment according to step (2).

15. The process as claimed in claim 10, wherein a stabilizer is added before or during the treatment according to step (2).

16. The process as claimed in claim 11, wherein a stabilizer is added before or during the treatment according to step (2).

17. The process as claimed in claim 10, wherein the process is carried out batchwise.

18. A polyetherol obtainable by a process at least comprising the following steps
(1) reaction of at least one alkylene oxide with at least one initiator compound in the presence of at least one double metal cyanide compound to give a polyetherol; and
(2) treatment of the polyetherol from step (1) with steam or with an inert gas and steam.

19. A method of synthesizing a polyurethane comprising utilizing a polyetherol obtained by the process as claimed in claim 10 in a polyurethane synthesis process.

20. The method as claimed in claim 19, wherein the polyurethane is a flexible polyurethane foam.

21. A process for the preparation of at least one polyetherol, at least comprising the following steps
(1) reaction of at least one alkylene oxide with at least one initiator compound in the presence of at least one double metal cyanide compound to give a polyetherol; and
(2) treatment of the polyetherol from step (1) with steam or with an inert gas and steam,
wherein a pH of less than 10 is present during the treatment according to step (2), and
wherein the treatment according to step (2) is carried out using steam alone.

22. The A process for the preparation of at least one polyetherol, at least comprising the following steps
(1) reaction of at least one alkylene oxide with at least one initiator compound in the presence of at least one double metal cyanide compound to give a polyetherol; and
(2) treatment of the polyetherol from step (1) with steam or with an inert gas and steam,
wherein a pH of less than 10 is present during the treatment according to step (2),
wherein the treatment according to step (2) is carried out using steam alone, and
wherein step (2) is carried out within 12 hours after step (1).

23. A process for the preparation of at least one polyetherol, at least comprising the following steps
(1) reaction of at least one alkylene oxide with at least one initiator compound in the presence of at least one double metal cyanide compound to give a polyetherol; and
(2) treatment of the polyetherol from step (1) with steam or with an inert gas and steam,
wherein a pH of less than 10 is present during the treatment according to step (2), and
wherein the polyetherol has an acid number of from 0.01 to 0.5 mg KOH/g before the treatment according to step (2).

24. A process for the preparation of at least one polyetherol, at least comprising the following steps
(1) reaction of at least one alkylene oxide with at least one initiator compound in the presence of at least one double metal cyanide compound to give a polyetherol; and
(2) treatment of the polyetherol from step (1) with steam or with an inert gas and steam,
wherein a pH of less than 10 is present during the treatment according to step (2),
wherein the treatment according to step (2) is carried out using steam alone, and
wherein the polyetherol has an acid number of from 0.01 to 0.5 mg KOH/g before the treatment according to step (2).

25. A process for the preparation of at least one polyetherol, at least comprising the following steps
(1) reaction of at least one alkylene oxide with at least one initiator compound in the presence of at least one double metal cyanide compound to give a polyetherol; and
(2) treatment of the polyetherol from step (1) with steam or with an inert gas and steam,
wherein a pH of less than 10 is present during the treatment according to step (2), and
wherein a stabilizer is added before or during the treatment according to step (2).

26. A process for the preparation of at least one polyetherol, at least comprising the following steps
(1) reaction of at least one alkylene oxide with at least one initiator compound in the presence of at least one double metal cyanide compound to give a polyetherol; and
(2) treatment of the polyetherol from step (1) with steam or with an inert gas and steam,
wherein a pH of less than 10 is present during the treatment according to step (2),
wherein the treatment according to step (2) is carried out using steam alone, and
wherein a stabilizer is added before or during the treatment according to step (2).

27. A process for the preparation of at least one polyetherol, at least comprising the following steps
(1) reaction of at least one alkylene oxide with at least one initiator compound in the presence of at least one double metal cyanide compound to give a polyetherol; and
(2) treatment of the polyetherol from step (1) with steam or with an inert gas and steam,
wherein a pH of less than 10 is present during the treatment according to step (2),
wherein the polyetherol has an acid number of from 0.01 to 0.5 mg KOH/g before the treatment according to step (2), and
wherein a stabilizer is added before or during the treatment according to step (2).

28. A process for the preparation of at least one polyetherol, at least comprising the following steps
(1) reaction of at least one alkylene oxide with at least one initiator compound in the presence of at least one double metal cyanide compound to give a polyetherol; and
(2) treatment of the polyetherol from step (1) with steam or with an inert gas and steam,
wherein a pH of less than 10 is present during the treatment according to step (2),
wherein the treatment according to step (2) is carried out using steam alone,
wherein the polyetherol has an acid number of from 0.01 to 0.5 mg KOH/g before the treatment according to step (2), and
wherein a stabilizer is added before or during the treatment according to step (2).
